(19) United States
(12) Patent Application Publication
(10) Pub. No.: US 2010/0215340 A1
(43) Pub. Date: Aug. 26, 2010

(54) Triggers For Launching Applications

(75) Inventors: Bradley R. Pettit, Los Gatos, CA (US); Eric R. Soldan, Saratoga, CA (US); James A. Baldwin, Redwood City, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/390,260

(22) Filed: Feb. 20, 2009

(51) Int. Cl. H04N 5/91

(52) U.S. Cl. 386/83; 386/E05.003

(57) ABSTRACT

This document describes tools capable of enabling television consumer devices to launch applications using triggers. A trigger may act to save limited resources on a television consumer device by triggering launch of an application not stored on the television consumer device. A trigger may include a payload portion and a criteria portion. When criteria in the criteria portion is satisfied by the playback of media content, an action in the payload portion is performed. In one embodiment, the tools enable a television consumer device to associate a trigger with a piece of media content. Responsive to playing back the piece of media content, the trigger launches an application that associates additional triggers with the piece of media content.

### BACKGROUND

Many current television consumer devices, such as set-top boxes and computers, are used with television monitors to display television programming. Some current television consumer devices, however, can do much more. Many set-top boxes, for example, can also play applications concurrently with television programming.

Consider, for example, a set-top box that is coupled to a television that is currently displaying a football game. This set-top box may play an application concurrently with the football game and respond to specific events that occur during the football game. The application may display a current score and current statistics of the football game at the bottom of the television screen every time the football game goes to a commercial break. Or the application may play the fight song of the home team every time the home team scores a touchdown.

This example application improves the viewer's experience by providing enhanced functionality to the viewer. Many current television consumer devices, however, have limited resources for storing applications, which may limit the number, size, and usefulness of these and similar applications.

### SUMMARY

This document describes tools capable of enabling television consumer devices to launch applications using triggers. A trigger may act to save limited resources on a television consumer device by triggering launch of an application not stored on the television consumer device. A trigger may include a payload portion and a criteria portion. When criteria in the criteria portion is satisfied by the playback of media content, an action in the payload portion is performed. In one embodiment, the tools enable a television consumer device to associate a trigger with a piece of media content. Responsive to playing back the piece of media content, the trigger launches an application that associates additional triggers with the piece of media content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The same numbers are used throughout the drawings to reference like features and components.

FIG. 1 illustrates an example consumer device in accordance with one or more embodiments.

FIG. 2 illustrates an example trigger in accordance with one or more embodiments.

FIG. 3 illustrates an example application store in accordance with one or more embodiments.

FIG. 4 is a flowchart illustrating an example method in accordance with one or more embodiments.

FIG. 5 is a flowchart illustrating an example method in accordance with one or more embodiments.

FIG. 6 illustrates an example system in which one or more embodiments of triggers for launching applications can be implemented.

FIG. 7 illustrates various components of an example consumer device that can implement one or more embodiments of triggers for launching applications.

FIG. 8 illustrates an example entertainment and information system in which one or more embodiments of triggers for launching applications can be used.

### DETAILED DESCRIPTION

Triggers can be associated with media content, such as television programs, to provide the media content with enhanced functionality. Each trigger may have a criteria portion and a payload portion. The payload portion identifies one or more actions to be performed (e.g., launching an application that provides enhanced functionality to the media content) when the criteria in the criteria portion is satisfied.

Consider an example football-game application. The tools may provision a television consumer device with a trigger that launches an application that displays a current score and current statistics of a football game at the bottom of a television screen every time the football game goes to a commercial break. In this example the trigger's criteria is playback of the football game and the action is launching the application. The application may itself associate a trigger with the football game also; this trigger may have a criteria of a commercial break being displayed and an action to provide a current score and statistics of the game.

Triggers can be provisioned triggers or application-based triggers. A provisioned trigger refers to a trigger that is distributed to a consumer device by some remote device or component. This distribution is initiated by the remote device or component, and the provisioned triggers may remain on the consumer device until they expire or are updated by the remote device or component. An application-based trigger is added to the consumer device by an application or module running on the consumer device. Application-based triggers often remain on the consumer device only while the application is running, such as in the football-game example mentioned above.

Many consumer devices have limited resources for storing both triggers and applications on the consumer device. There are often hundreds or even thousands of different television shows each of which may have corresponding triggers and applications. It can be difficult, therefore, for a television consumer device with limited resources to store so many triggers and applications.

The tools described in this document enable consumer devices to be provisioned with as few as one trigger for each piece of media content. For example, a consumer device can be provisioned with a single trigger for each portion of a specific football game, a specific comedy show, or a specific late-night talk show. When the media content is played back for viewing on the consumer device, the single trigger associated with the media content can initiate the launch of an application that is stored remotely, such as at a remote distribution server. The application, when launched at the consumer device, can add additional triggers associated with the media content being played for viewing to the consumer device. These additional triggers may remain on the consumer device while the media content is played for viewing, and may be removed from the device when the media content stops playing.

Storing applications configured to associate triggers with media content at a remote location improves the scalability of triggers by freeing up resources at the consumer device. For example, rather than wasting resources on the consumer device with thousands of triggers that may go unused, a consumer device can instead be configured with as few as a single trigger for each piece of media content.

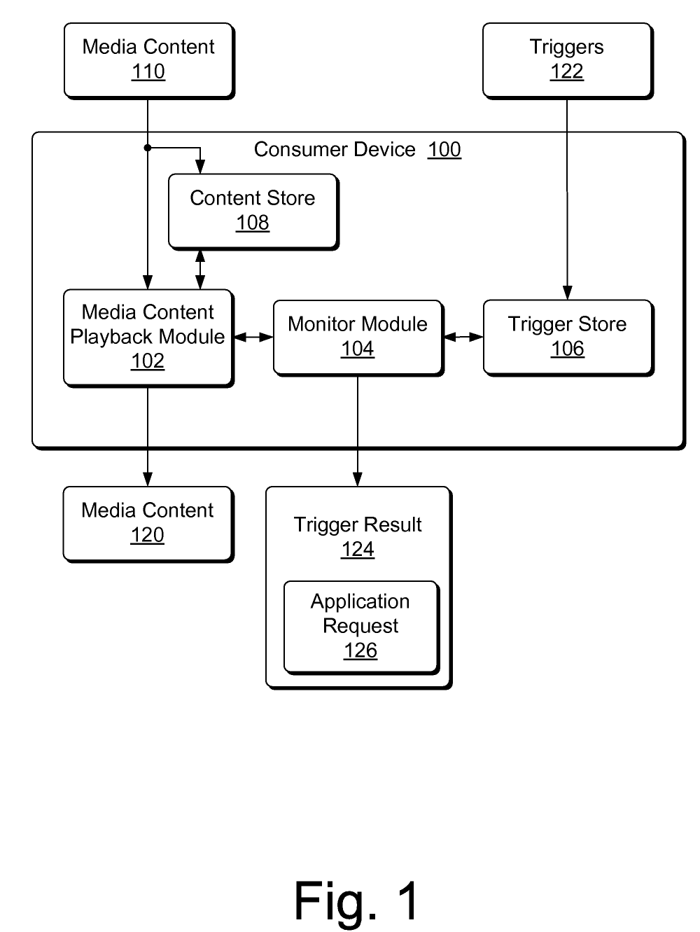

FIG. 1 illustrates an example consumer device 100 in accordance with one or more embodiments. Consumer device 100 can be any of a variety of devices that output video for display. For example, consumer device 100 can be a computer, such as a desktop computer, server computer, a mobile station, an entertainment appliance, a set-top box communicatively coupled to a display device, a video playback device (e.g., a digital video recorder (DVR), a digital versatile disk (DVD) player, or a recorder), a television, a cell or other wireless phone, a game console, an automotive PC, and so forth. Thus, consumer device 100 can range from full-resource devices with substantial memory and processor resources (e.g., personal computers and game consoles) to a low-resource device with limited memory and/or processing resources (e.g., traditional set-top boxes, hand-held game consoles, and DVD players).

Consumer device 100 includes a media content playback module 102, a monitor module 104, a trigger store 106, and a content store 108. Media content refers to one or more of a variety of different types of content that can be played back to a user. Oftentimes media content is audio/video content such as movies, sitcoms, commercials, news broadcasts, documentaries, sporting events, and so forth. The media content can thus be referred to as being or including a particular program. Alternatively, media content can be only one type of content (e.g., just audio content or just video content), or can be other types of content (e.g., images or text).

Media content playback module 102 receives media content 110 and outputs media content 120. Media content 110 can be received directly by playback module 102 or alternatively can be received via content store 108. Content store 108 allows for time-shifted viewing of media content and providing other storage for media content 110. Although illustrated as part of consumer device 100, it is to be appreciated that content store 108 can be implemented on removable media (e.g., magnetic disk, optical disc, or flash memory) and/or remote storage devices (e.g., a server computer or another consumer device).

Media content playback module 102 converts media content 110 into a format that can be played back by a display device and outputs the converted media content as media content 120. Media content playback module 102 can also receive input from a user (e.g., via a remote control device) or other component or module of device 100 to control the output of media content 120, such as to pause playback of the content, select particular media content for playback, fast forward or rewind through the media content, and so forth.

Media content 110 can be distributed to consumer device 100 in a variety of different manners. The sources of media content 110 can be local sources, such as a hard disk or a DVD that is inserted into, coupled to, or included as part of consumer device 100. The sources of media content 110 can also be remote sources, such as remote servers, satellite operators, network television operators, cable operators, or other devices or operators making content 110 available to consumer device 100. Remote sources can make content 110 available over a variety of different types of transmission media, such as of satellite transmissions, radio-frequency transmissions, cable transmissions, the Internet, a wide-area network (WAN), a local-area network (LAN), a wireless network, a telephone network, an intranet, and so forth.

In some cases media content 110 is aired over transmission media and received by consumer device 100. The airing of media content refers to the transmitting of the program by the source via a transmission media. The aired media content 110 can be stored in content store 108 for time-shifted playback. Alternatively, media content 110 can be played back as it is received without being stored in content store 108. In other embodiments, media content 110 can be distributed using other techniques, such as optical discs, flash memory, and so forth.

Trigger store 106 receives and stores triggers 122. Each trigger 122 may include a payload portion identifying actions to be performed and a criteria portion identifying criteria to be satisfied for the actions to be performed. Although illustrated as separate from content store 108, alternatively trigger store 106 and content store 108 can be implemented as a single store. Additionally, although illustrated as part of consumer device 100, it is to be appreciated that trigger store 106 can be implemented on removable media and/or remote storage devices (e.g., a server computer or consumer device).

Triggers 122 can be distributed to consumer device 100 in a variety of different manners. Analogous to media content 110, triggers 122 can be received from local sources or remote sources distributing triggers 122 over a variety of different transmission media or using other distribution techniques. By way of example, triggers 122 can be received with media content 110, can be received with programming-guide data, can be received via a separate communication with a trigger source, and so forth. These triggers may be sent by various sources, such as a content distributor (e.g., a broadcasting entity), and at various times, such as during a live program. For example, a content distributor may send a trigger during a live program with a payload extending a recording end time beyond a scheduled end time. Consider a sports program scheduled to end at 2:30 pm that goes into overtime—in such a case the content distributor may send a trigger indicating that the program be recorded past 2:30 pm, such as to 3:00 pm or until the game completes.

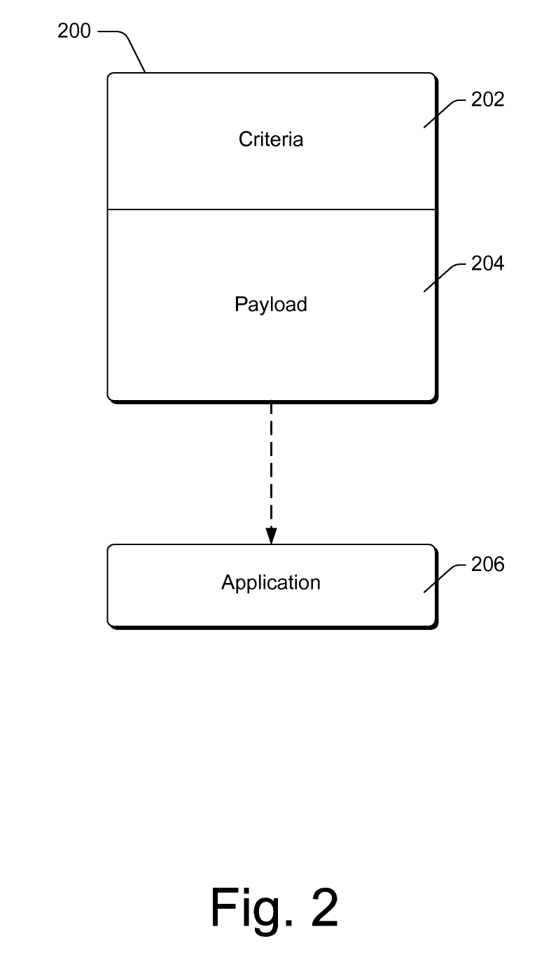

FIG. 2 illustrates an example trigger 200 in accordance with one or more embodiments. Trigger 200 includes a criteria portion 202 and a payload portion 204. Criteria portion 202 identifies parameters or criteria to be satisfied for actions identified in payload portion 204 to be performed. These one or more criteria may include an identifier of particular media content. This identifier may include a title or name of the particular media content or a summary or other description of the content, to name a few. When such criteria are included in criteria portion 202, the actions in payload portion 204 are performed when that particular identified media content is presented.

Criteria portion 202 may include a time range, such as a few seconds or even days. During presentation of media content, a current time is maintained, and when such time range criteria is included in criteria portion 202, actions in payload portion 204 are performed when the current time is within the time range identified in criteria portion 202. Note that the current time can be an actual time or a time relative to a program, such as four minutes into a thirty-minute program.

Criteria portion 202 may also or instead include a channel identifier. This channel identifier can be a channel number, a call sign or other identifier of a broadcaster associated with the channel, and so forth. When such criteria are included in criteria portion 202, actions in payload portion 204 are performed when the media content on that identified channel is presented or that channel is tuned to.

Payload portion 204 identifies actions to be performed when the criteria of criteria portion 202 is satisfied. Indicating that the actions in payload portion 204 are to be performed due to the criteria in portion 202 being satisfied is also referred to as “firing” trigger 200. A variety of different actions can be included in payload portion 204. These actions can include displaying or otherwise presenting advertisements or other information, running a particular application or program, loading and displaying a Web page, creating a new trigger, performing actions identified in the payload portions of other triggers, and so forth.

Payload portion 204 can be configured to initiate the launch of an application 206. Initiating the launch of an application can include sending an application request (e.g., application request 126 of FIG. 1) to initiate the launch of an application associated with media content being played back. In some instances, the application request can identify a specific application or component to be launched. Alternately, a general application request can be sent to a variety of different applications and/or components configured to monitor and respond to trigger requests.

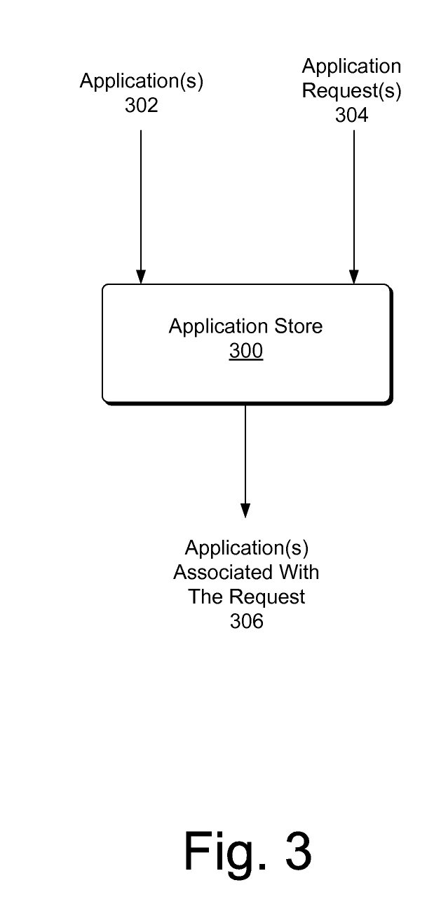

FIG. 3 illustrates an application store 300, which can be implemented as part of consumer device 100 or as removable media (e.g., magnetic disk, optical disc, or flash memory). Alternately or additionally, application store 300 can be located remote from consumer device 100 and implemented as a part of remote storage devices (e.g., a server computer or device accessible by consumer device 100).

Application store 300 is configured to receive applications 302 and application requests 304. Applications 302 can be received from local sources or remote sources over a variety of different transmission media or using other distribution techniques. Application developers can provide applications that are associated with specific application requests. For instance, an application may be associated with a specific television show such that when a trigger associated with the specific television show fires on a consumer device, the application store sends the application to the consumer device.

Application store 300 includes or has access to a database for storing application 302. Each application 302 is associated with at least one of the application requests 304 (e.g., application request 126 of FIG. 1). Application store 300 is configured to monitor the application request 304 and determine whether any of applications 302 are associated with the application request. Responsive to determining that an application is associated with (e.g., subscribed to) an application request, application store 300 may output an application associated with the request 306. The application associated with the request 306 can be configured to associate triggers with media content when launched at a consumer device.

Returning to FIG. 1, monitor module 104 monitors data of media content 110 to identify when the criteria of triggers 122 are satisfied. Monitor module 104 can communicate with playback module 102 to identify the particular media content 120 being output by module 102 at any given time. Alternatively, monitor module 104 can receive media content 110 (directly or via content store 108) and monitor this received content directly rather than via playback module 102. Monitor module 104 can monitor data of media content 110 as media content 110 is received from content store 108 or alternatively from another source.

Triggers 122 may correspond to particular media content. This correspondence can be identified in a variety of different manners, such as in the criteria portion of the media content. Triggers 122 can also or instead be collected or grouped together in trigger store 106 based on their corresponding media content. Trigger 122 can correspond to all media content, to multiple different media content, and so forth.

Monitor module 104 monitors one or more of different types of content included in media content 110. For example, monitor module 104 can monitor audio content and video content. In some cases media content 110 includes metadata content, and monitor module 104 can monitor this metadata content. The metadata may also be included as part of other types of content. Alternatively, the metadata can be separate from other types of content, such as being included in a separate stream or channel from the audio or video content. This metadata included in media content 110 is associated with and describes the audio, video, and/or other types of content in media content 110. Examples of such metadata include closed-captioning data, which is a text version of the audio content included in media content 110, teletext data corresponding to media content 110, song or program title information corresponding to media content 110, and so forth.

When the data of media content 110 satisfies the criteria of a trigger 122, the actions identified in that trigger 122 are performed. The data of media content 110 being monitored can include the media content 110 itself, such as metadata, video content, audio content, and so forth. The media content 110 itself can be monitored to identify particular text (e.g., particular letters, numbers, symbols, and so forth), particular images, particular audio data, and so forth. The particular manner in which media content 110 is monitored is based at least in part on the triggers 122. For example, if a trigger 122 indicates that one criteria is particular text that is to occur in media content 110, then monitor module 104 monitors the media content for that particular text.

The data of media content 110 being monitored can also include different data describing the playback of media content 110. This different data can be obtained from different sources, such as included as part of media content 110 (e.g., header information describing media content 110), from media content playback module 102, from content store 108, and so forth. A variety of different data describing the playback of media content 110 can be monitored, such as a television channel that is tuned to for playback, the title of program being played back as the media content, and so forth.

When monitor module 104 determines that one or more of the criteria of a trigger 122 are satisfied, monitor module 104 performs the actions in the payload portion of that trigger. In response to performing these actions, monitor module 104 generates a trigger result 124 output by consumer device 100. Trigger result 124 may include an application request 126 configured to initiate the launch of applications. Alternately or additionally, trigger result 124 includes the output of a variety of different types of content, such as video content, image content, audio content, and so forth.

Trigger result 124 can be displayed or otherwise presented concurrently with media content 120. For example, trigger result 124 can be video content or an image that is displayed or overlaid on media content 120, such as a small icon at the bottom of a display. Trigger result 124 can also or additionally be audio content played back concurrently with media content 120. It may also be displayed in a separate portion or window (e.g., in a picture-in-picture (PIP) window) from media content 120 or, as above, displayed or otherwise presented separately from the display or other presentation of media content 120.

Actions in the payload portion of a trigger can involve initiating the launch of an application on device 100 (e.g., application 206 of FIG. 2). Payload portion 204 can initiate the launch an application by sending an application request 126. Payload portion 204, for example, can send an application request 126 to application store 300. A variety of different types of applications can be launched by the payload portion. For example, the application can be configured to present a user interface to a user of device 100. This user interface can display or otherwise present information to the user, such as advertising content, a web page (e.g., retrieved over the Internet from a URL in the trigger), additional information describing the media content being presented, and so forth. The user interface can also support user interaction, allowing the user to input a variety of different information or selections, such as entering an email address of the user, selecting a link to a web page, selecting a displayed icon, and so forth.

The application may, in some cases, associate additional triggers with the media content that triggered the launch of the application. For instance, the application can add additional triggers to trigger store 106 associated with the media content being played back on the consumer device. The additional triggers can include a criteria portion and a payload portion just like trigger 200. In this way, media content can be associated with as few as a single trigger, which can be used to initiate the launch of an application that associates additional triggers with the media content.

Monitor module 104 sends an application request to an application store (e.g., application store 300 of FIG. 3). The application store, in some instances, is located remote from the consumer device, such as at a remote server. Responsive to receiving the application request, the application store sends applications associated with the media content to the consumer device 100. The applications may be configured to add additional triggers associated with the media content to trigger store 106.

Storing applications configured to associate triggers with media content at an application store located remote from the consumer device improves the scalability of triggers by freeing up resources at the consumer device. Many different triggers may be associated with each piece of media content, such as a football game. Rather than configuring the consumer device with hundreds of triggers for the single football game, therefore, the football game can be configured with as few as a single trigger. Then, when the football game is played back on the consumer device, the single trigger can initiate the launch of an application that can configure the consumer device with additional triggers associated with the football game. In addition, configuring media content with a single trigger that sends an application request enables application developers to subsequently develop applications that can subscribe to various application requests.

In some cases all of the criteria included in the criteria portion of the trigger are satisfied for the actions in the payload portion to be performed. Alternatively, various logical operators, such as “AND” and “OR”, may be used in conjunction with the criteria to allow different combinations to be defined. Four different criteria can be listed, for example, at least one of which is to be satisfied in order for the actions to be performed.

Additionally, it should be noted that criteria can be full-match or partial-match criteria. Full-match criteria indicates that the criteria is to match the data of the programming content exactly, whereas partial-match criteria indicates that the data of the programming is to include at least the partial-match criteria. For example, if the data of the programming were “Microsoft Corporation” and the criteria were “Corporation,” then the criteria is a partial-match to the data of the programming but not a full-match. Whether criteria is full-match or partial-match can be inherent in the particular criteria, or identified in other manners such as including a flag or other value with the criteria indicating whether it is full-match or partial-match.

Furthermore, partial-match criteria can be a “starts-with” partial-match, an “anywhere” partial-match, or other type of partial-match. A starts-with partial-match indicates that the data of the programming is to start with the criteria, whereas an anywhere partial-match indicates that the criteria can be included anywhere in the data of the programming. For example, if the data of the programming were “Microsoft Corporation” and the criteria were “Corporation,” then the criteria is an anywhere partial-match to the data of the programming but not a starts-with partial-match. Other types of partial matches can also be defined using regular expressions. For example, quantifiers or wild cards can be used, such as “*” to indicate zero or more characters, “?” to indicate zero or one characters, and so forth. Whether partial-match criteria is starts-with or anywhere criteria, or alternatively other criteria, can be inherent in the particular criteria or can be identified in other manners such as including a flag or other value with the criteria indicating whether it is starts-with or anywhere.

As discussed above, a variety of different criteria or parameters can be included in the criteria portion of a trigger. Table I lists example criteria that can be included in the criteria portion of a trigger in accordance some embodiments. It is to be appreciated that Table I lists only example criteria and that not all of the criteria in Table I need be used, or alternatively additional criteria can be included. Criteria are not necessarily case-sensitive.

TABLE I

| Criteria | Description |
|---|---|
| Keyword | One or more keywords to occur in the media content. |
| Title | The title of a program that is included in the media content. |
| Episode | The episode of a program that is included in the media |
| | content. |
| Description | A description of a program that is included in the media |
| | content. |
| Actor List | One or more actors or actresses that appear in a program |
| | that is included in the media content. |
| Director | One or more directors of a program that is included in the |
| | media content. |
| Currently | A call sign of the channel via which the media content is |
| tuned | being received. |
| channel call | |
| sign | |
| Currently | A number of the channel via which the media content is |
| tuned | being received. |
| channel | |
| number | |
| DateTime | A beginning date and/or time for the trigger. This criteria is |
| Beginning | satisfied only if the current date and/or time is after the |
| | beginning date and/or time. |
| DateTime | An ending date and/or time for the trigger. This criteria is |
| Ending | satisfied only if the current date and/or time is before the |
| | ending date and/or time. |
| DateTime | An expiration date and/or time for the trigger. This criteria |
| Expire | is satisfied only if the current data and/or time is before the |
| | expiration date and/or time. The trigger can optionally be |
| | removed (e.g., by monitor module 104) after the expiration |
| | date and/or time. |
| Program- | A time value which is added to the program's beginning |
| relative | DateTime. If no time value is specified, then the program's |
| Beginning | beginning DateTime is used. This derived value is then |
| Time | used as the comparison criteria, comparing against the |
| | current DateTime value. This criteria is satisfied only if the |
| | current DateTime is greater than or equal to the |
| | derived value. |
| Program- | A time value which is added to the program's beginning |
| relative | DateTime. If no time value is specified, then the program's |
| Ending Time | ending DateTime is used. This derived value is then used as |
| | the comparison criteria, comparing against the current |
| | DateTime value. This criteria is satisfied only if the current |
| | DateTime is less than or equal to the derived value. |

Some additional example triggers and trigger formats are discussed below. One example trigger is:

[TITLE:xyz], [EVENT:act1]

This example trigger indicates that the criteria are a program title (TITLE) that is “xyz”. If that criteria is satisfied then an action (EVENT) of “act1” is to be performed. This action “act1” can be, for example, launching an application by sending an application request, as discussed above.

Another example trigger is:
[TITLE:xyz], [CHANNEL:274], [EVENT:act1]
   This example trigger indicates that the criteria are: a program title (TITLE) that is “xyz”; and a channel on which the program is played back (CHANNEL) is “274”. If the criteria are satisfied, then an action (EVENT) of “act1” is to be performed. This action “act1” can be, for example, launching an application by sending an application request, as discussed above.

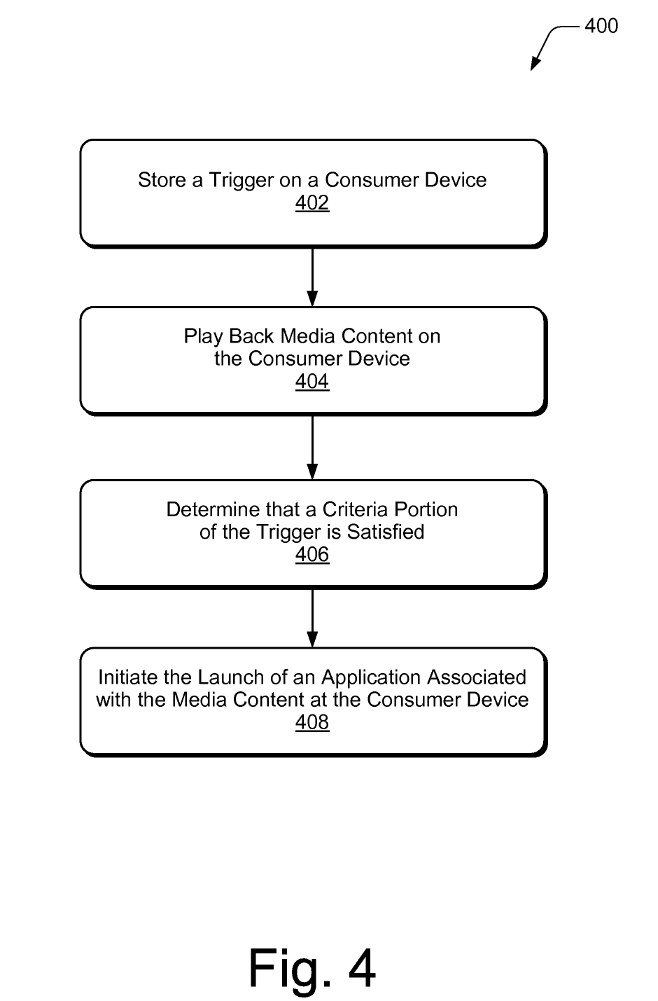

FIG. 4 is a flowchart illustrating an example method 400. Method 400 may be carried out by a device, such as consumer device 100 of FIG. 1, and may be implemented in software, firmware, hardware, or combinations thereof.

At 402, a trigger is stored on a consumer device. The trigger can include a criteria portion and a payload portion, as discussed with regards to FIG. 2.

At 404, media content is played back on the consumer device, and at 406, it is determined that a criteria portion of the trigger is satisfied. For instance, as discussed with regards to FIG. 1, monitor module 104 can be configured to monitor data corresponding to media content played back and detect when the data satisfies the criteria portion of a trigger.

At 408, the launch of an application at the consumer device is initiated. As discussed above, the application may be associated with the media content played back. For instance, as discussed with regards to FIG. 1, monitor module 104 can implement the payload portion of the trigger by sending an application request to an application store, such as application store 300 of FIG. 3. The application store may be an entity located remote from the consumer device, such as at a remote server. The application, when launched at the consumer device, may associate additional triggers with the media content. For example, the application may add additional triggers to trigger store 106 that are associated with the media content.

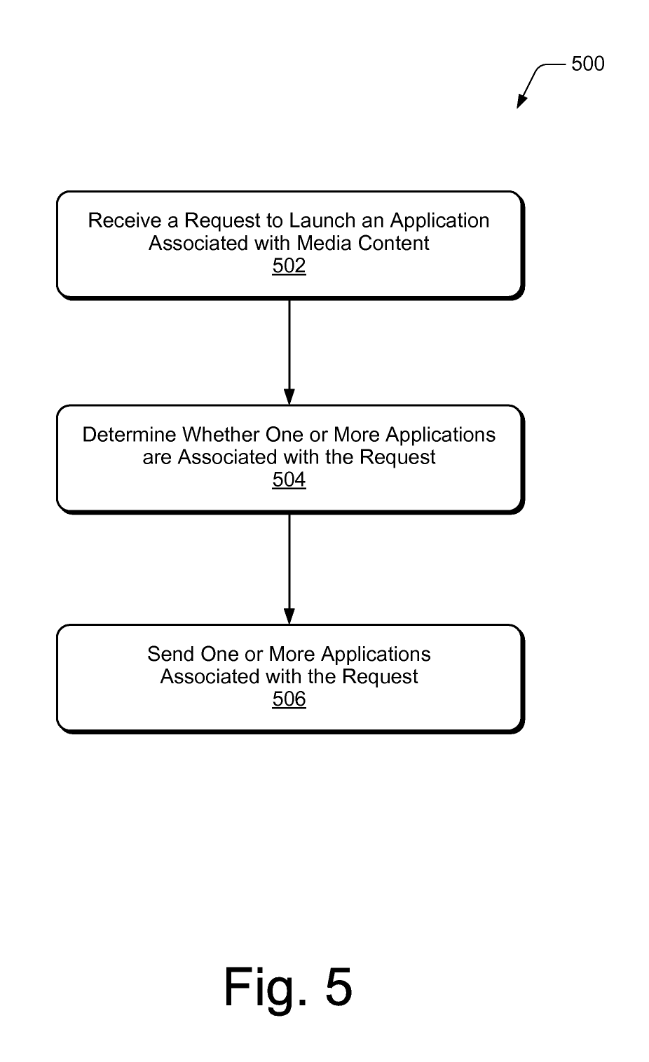

FIG. 5 is a flowchart illustrating an example method 500. Method 500 can be carried out by application store 300 of FIG. 3 or otherwise, and can be implemented in software, firmware, hardware, or combinations thereof.

At 502, a request to launch an application associated with media content is received. The request may be received, for example, from a consumer device such as consumer device 100 of FIG. 1. The request may be received from an entity (e.g., a consumer device) located remote from the application store.

At 504, it is determined whether applications are associated with the request and at 506 applications associated with the request are sent. The applications can be configured to launch at a consumer device (e.g., consumer device 100 of FIG. 1). When launched, the applications may associate triggers with media content. An application launched at consumer device 100, for example, may add triggers to trigger store 106. The applications may be sent to a device located remote from the application store.

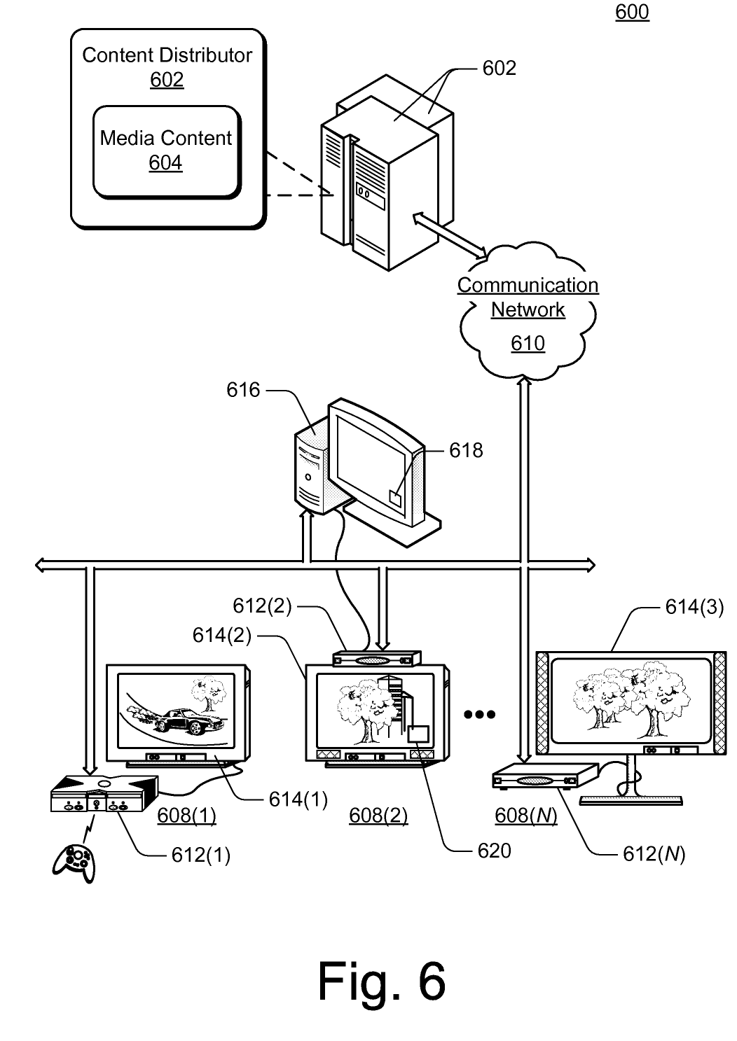

FIG. 6 illustrates an example system 600 in which embodiments of triggers for launching applications can be implemented. System 600 includes content distributors 602 that communicate media content 604 to any number “N” of various television client systems 608(1-N) via a communication network 610. Client systems 608 can each be, for example, a different type (or alternatively the same types) of consumer device 100 of FIG. 1. Communication network 610 can be implemented to include an IP-based network that facilitates media content distribution and data communication between the content distributor(s) 602 and any number of television client devices.

Each of client systems 608(1-N) includes a respective television client device 612(1-N) and a respective display device 614(1-N), such as any type of television, monitor, LCD, projector, or similar television-based display system that renders audio, video, and/or image data. Any of client devices 612(1-N) can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device. Any of television client devices 612(1-N) may also be associated with a user (e.g., a person) and/or an entity that operates a client device such that a television client device describes logical clients that include users, software, and/or devices.

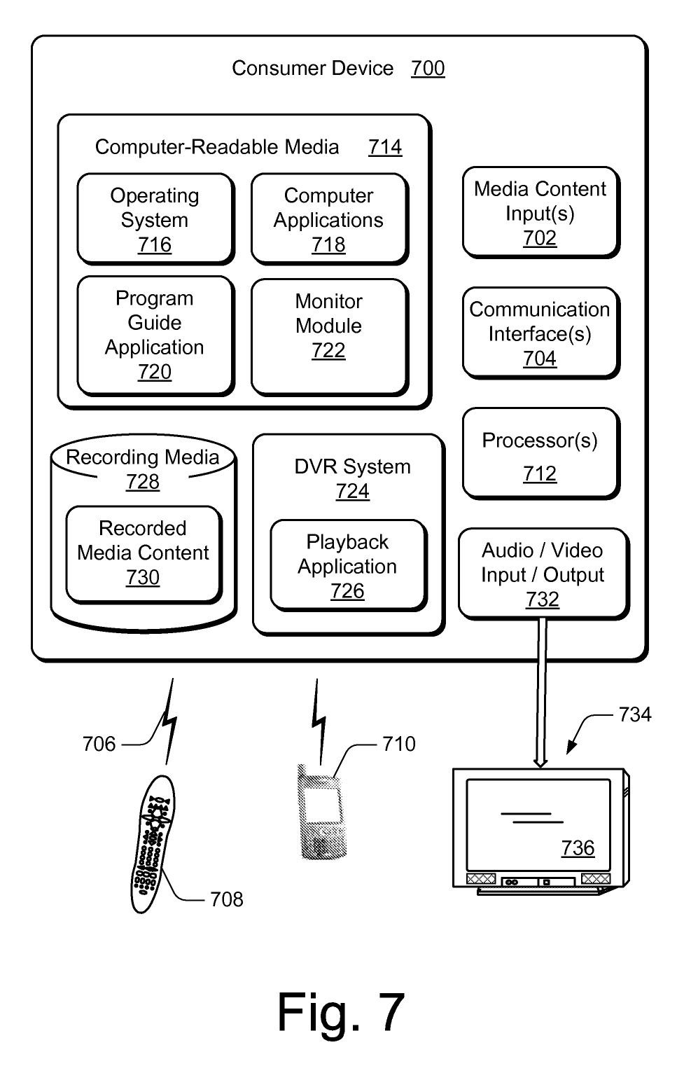

Any of television client devices 612(1-N) of the respective client systems 608(1-N) can be implemented with one or more processors, a communication module, memory components, a media content rendering system, and a monitor module and trigger store to implement embodiments of triggers for launching applications. Additionally, each of television client devices 612(1-N) can be configured for communication with any number of different content distributors 602 to receive any type of media content 604 via the communication network 610. Further, any of the television client devices 612(1-N) can be implemented with any number and combination of differing components as further described with reference to the example consumer device shown in FIG. 7.

In this example, client device 612(2) is a television set-top box that is connected, or otherwise communicatively linked, to a computing device 616 that can be implemented to display trigger results 618. Although example trigger results 618 are illustrated in FIG. 6, it is to be appreciated that trigger results 618 can be presented in other manners as discussed above. Computing device 616 can also be configured for communication with a content distributor 602 to receive the trigger (e.g., triggers 122 of FIG. 1) via the communication network 610.

FIG. 7 illustrates various components of an example consumer device 700 that can be implemented as any form of a computing, electronic, or television client device to implement embodiments of triggers for launching applications. For example, consumer device 700 can be implemented as consumer device 100 shown in FIG. 1, and/or as any of the client devices 612(1-N) of client systems 608(1-N) shown in FIG. 6. In various embodiments, consumer device 700 can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device.

Consumer device 700 includes media content inputs 702 that may include Internet Protocol (IP) inputs over which streams of media content are received via an IP-based network. Consumer device 700 further includes communication interface(s) 704 that can be implemented as any of a serial and/or parallel interface, a wireless interface, any type of network interface, a modem, and as any other type of communication interface. A wireless interface enables client device 700 to receive control input commands 706 and other information from an input device, such as from remote control device 708, a portable computing-based device (such as a cellular phone) 710, or from another infrared (IR), 802.11, Bluetooth, or similar RF input device.

A network interface provides a connection between consumer device 700 and a communication network by which other electronic and computing devices can communicate data with device 700. Similarly, a serial and/or parallel interface provides for data communication directly between client device 700 and the other electronic or computing devices. A modem facilitates client device 700's communication with other electronic and computing devices via a conventional telephone line, a DSL connection, cable, and/or other type of connection.

Consumer device 700 also includes one or more processors 712 (e.g., any of microprocessors, controllers, and the like), which process various computer-executable instructions to control the operation of device 700, to communicate with other electronic and computing devices, and to implement embodiments of triggers for launching applications. Consumer device 700 can be implemented with computer-readable media 714, such as memory components, examples of which include random access memory (RAM), nonvolatile memory (e.g., any one or more of a read-only memory (ROM), flash memory, EPROM, or EEPROM), and a disk storage device. A disk storage device can include any type of magnetic or optical storage device, such as a hard disk drive, a recordable and/or rewriteable compact disc (CD), a DVD, a DVD+RW, and the like.

Computer-readable media 714 provides data storage mechanisms to store various information and/or data such as software applications and any other types of information and data related to operational aspects of consumer device 700. For example, an operating system 716 and/or other computer applications 718 can be maintained as software applications with the computer-readable media 714 and executed on processor(s) 712 to implement embodiments of the triggers for launching applications.

Consumer device 700 can also include a program guide application 720 implemented to process program guide data and generate program guides for display. A program guide enables a viewer to navigate through an onscreen display and locate various media content such as broadcast programs, recorded programs, video on-demand programs and movies, interactive game selections, network-based applications, and other media content of interest to the viewer. Consumer device 700 can also include a monitor module 722 (shown as a software module in this example) to implement various embodiments of triggers for launching applications as described herein.

Consumer device 700 can also include a DVR system 724 with playback application 726, and recording media 728 to maintain recorded media content 730 that consumer device 700 receives and/or records. Further, consumer device 700 may access or receive additional recorded media content maintained with a remote data store (not shown). Consumer device 700 may also receive media content from a video on-demand server, or media content maintained at a broadcast center or content distributor that distributes the media content to subscriber sites and client devices. Playback application 726 is a video control application that can be implemented to control the playback of media content, the recorded media content 730, and/or other video on-demand media content, music, and any other audio, video, and/or image media content which can be rendered and/or displayed for viewing. Playback application 726 can be, for example, media content playback module 102 of FIG. 1.

Consumer device 700 also includes an audio and/or video output 732 that provides audio and/or video data to an audio rendering and/or display system 734. Audio rendering and/or display system 734 can include any devices that process, display, and/or otherwise render audio, video, and image data. Video signals and audio signals can be communicated from consumer device 700 to a display device 736 via an RF (radio frequency) link, S-video link, composite video link, component video link, DVI (digital video interface), analog audio connection, or other similar communication link. Alternatively, audio rendering and/or display system 734 can be implemented as integrated components of the example consumer device 700. Consumer device 700 along with the audio rendering and/or display system 734 is an example of a viewing system that can be implemented in a household viewing area for viewing television programs and/or receiving other television media content.

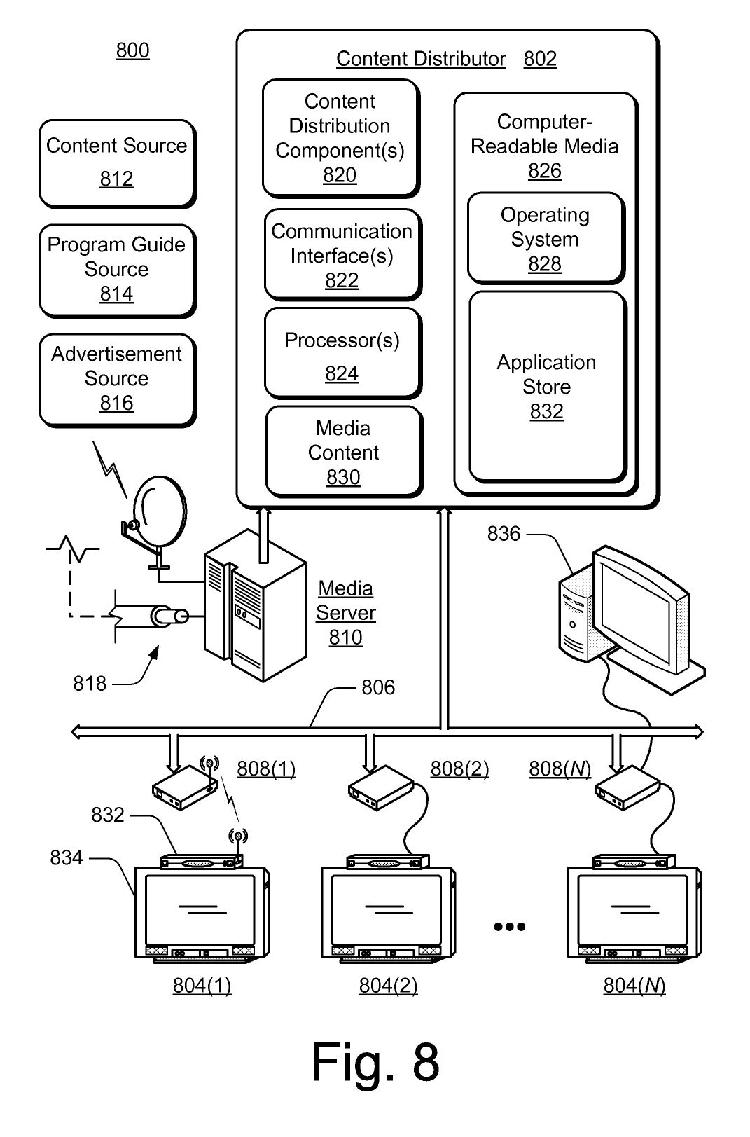

FIG. 8 illustrates an example entertainment and information system 800 in which one or more embodiments of triggers for launching applications can be implemented. System 800 facilitates the distribution of media content, program guide data, and advertising content to multiple viewers and to multiple viewing systems. System 800 includes a content distributor 802 and any number “N” of client systems 804(1-N) each configured for communication via a communication network 806. Each client system 804(1-N) is an example of the client systems 808(1-N) described with reference to FIG. 7. Each of the client systems 804(1-N) can receive data streams of media content, media content, program guide data, advertising content, closed captioning data, and the like from content server(s) of content distributor 802 via communication network 806.

Communication network 806 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 806 can be implemented using any type of network topology and any network communication protocol, and can be represented or otherwise implemented as a combination of two or more networks. A digital network can include various hardwired and/or wireless links 808(1-N), routers, gateways, and so on to facilitate communication between content distributor 802 and client systems 804(1-N).

System 800 includes a media server 810 that receives media content from a content source 812, program guide data from a program guide source 814, and advertising content from an advertisement source 816. This advertising content can be advertising content associated with triggers as discussed above (e.g., advertising content displayed when the criteria of a trigger is satisfied), and/or different advertising content presented to users of system 800. In one or more embodiments, media server 810 represents an acquisition server that receives the audio and video media content from content source 812, an EPG server that receives the program guide data from program guide source 814, and/or an advertising management server that receives the advertising content from the advertisement source 816.

Content source 812, program guide source 814, and advertisement source 816 control distribution of the media content, the program guide data, and at least some of the advertising content to the media server 810 and/or to other servers. The media content, program guide data, and advertising content can be distributed via various transmission media 818, such as satellite transmission, radio frequency transmission, cable transmission, and/or via any number of other wired or wireless transmission media. In this example, media server 810 is shown as an independent component of system 800 that communicates the media content, program guide data, and advertising content to content distributor 802. In an alternate implementation, media server 810 can be implemented as a component of content distributor 802.

Content distributor 802 is representative of a service in a content distribution system that provides the media content, program guide data, and advertising content to multiple subscribers (e.g., the client systems 804(1-N)). Content distributor 802 can be implemented as a satellite operator, a network television operator, a cable operator, and the like to control distribution of media content, program and advertising content, such as movies, television programs, commercials, music, and other audio, video, and/or image content to client systems 804(1-N).

Content distributor 802 includes various content distribution components 820 to facilitate media content processing and distribution, such as a subscriber manager, a device monitor, and one or more content servers. The subscriber manager manages subscriber data, and the device monitor monitors client systems 804(1-N) (e.g., and the subscribers), and maintains monitored client state information.

Although the various managers, servers, and monitors of content distributor 802 (to include media server 810 in one or more embodiments) are described as distributed, independent components of content distributor 802, any one or more of the managers, servers, and monitors can be implemented together as a multi-functional component of content distributor 802. Additionally, any one or more of the managers, servers, and monitors described with reference to system 800 can implement features and embodiments of triggers for launching applications.

Content distributor 802 includes communication interface(s) 822 that can be implemented as any type of interface to communicate and receive data from client devices of the television system. Content distributor 802 also includes processors 824 (e.g., any of microprocessors, controllers, and the like), which process various computer-executable instructions to control the operation of content distributor 802. Content distributor 802 can be implemented with computer-readable media 826, which provides data storage to maintain software applications such as an operating system 828 and media content 830 for distribution to the client systems 804(1-N). Content distributor 802 can also include an application store 832 (shown as a software module in this example) to implement various embodiments of triggers for launching applications as described herein.

Client systems 804(1-N) can each be implemented to include a client device 832 and a display device 834 (e.g., a television, LCD, and the like). A client device 832 of a respective client system 804 can be implemented in any number of embodiments, such as a set-top box, a digital video recorder (DVR) and playback system, an appliance device, a gaming system, and as any other type of client device that may be implemented in an entertainment and information system. In an alternate embodiment, client system 804(N) is implemented with a computing device 836 as well as a client device. The computing device 836 is an example of a connected data store that can record and maintain media content for a client device. Additionally, any client device 832 of a respective client system 804 can implement features and embodiments of triggers for launching applications as described herein.

Generally, any of the functions or techniques described herein can be implemented using software, firmware, hardware (e.g., fixed logic circuitry), manual processing, or a combination of these implementations. The terms “module,” “component,” and “tool” as used herein generally represent software, firmware, hardware, or combinations thereof. In the case of a software implementation, these may represents program code that performs specified tasks when executed on a processor (e.g., CPU or CPUs). The program code can be stored in one or more computer-readable memory devices. The features of the triggers for launching applications techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
storing a trigger on a consumer device, the trigger configured to initiate the launch of an application responsive to playback of a piece of media content; and
responsive to the playback of the piece of the media content, initiating launch on the consumer device of the application associated with the piece of the media content using the trigger, the application configured to associate additional triggers with the media content, the additional triggers configured to provide enhanced functionality to the media content.

2. The method as recited in claim 1, wherein at least one of the additional triggers is configured to launch another application that provides the enhanced functionality to the media content.

3. The method as recited in claim 1, further comprising launching the application associated with the piece of the media content, the application associating the one or more additional triggers with the media content.

4. The method as recited in claim 1, wherein the application is stored at an application store remote from the consumer device.

5. The method as recited in claim 4, wherein initiating the launch of the application further comprises sending an application request to the application store.

6. The method as recited in claim 5, wherein a payload portion of the trigger identifies the application request.

7. The method as recited in claim 1, wherein the application is stored at an application store located on the consumer device.

8. One or more computer-readable media having stored thereon multiple instructions that, when executed by one or more processors of a consumer device, cause the one or more processors to:
store a trigger on the consumer device, the trigger comprising a criteria portion and a payload portion, the payload portion configured to send an application request responsive to the criteria portion being satisfied by the playback of a piece of media content;
determine during playback of the piece of media content that the criteria portion of the trigger is satisfied; and
send the application request identified in the payload portion of the trigger to a remote entity capable of providing the application to the consumer device.

9. One or more computer-readable media as recited in claim 8, the instructions further causing the one or more processors to:
receive the application from the remote entity; and
launch the application at the consumer device.

10. One or more computer-readable media as recited in claim 9, wherein the application is configured to associate one or more additional triggers with the piece of media content when the application is launched at the consumer device.

11. One or more computer-readable media as recited in claim 10, wherein the one or more additional triggers are configured to provide enhanced functionality to the media content.

12. One or more computer readable media as recited in claim 10, wherein at least one of the one or more additional triggers is configured to launch an application that provides enhanced functionality to the media content.

13. One or more computer-readable media as recited in claim 10, wherein associating one or more additional triggers with the piece of media content comprises storing the one or more additional triggers in a trigger store on the consumer device.

14. A system configured to:
store multiple triggers, each of the multiple triggers comprising a criteria portion and a payload portion, the criteria portion identifying one or more criteria and the payload portion identifying an application request;
monitor data corresponding to media content being played back;
detect when the data satisfies the one or more criteria of one or more of the multiple triggers;
send the application request identified in the payload portion of the one or more of the multiple triggers having the satisfied one or more criteria; and
receive the application associated with the application request.

15. The system as recited in claim 14, wherein the application is configured to associate one or more additional triggers with the media content being played back.

16. The system as recited in claim 15, wherein the one or more additional triggers are configured to provide enhanced functionality to the media content being played back.

17. The system as recited in claim 15, wherein each of the one or more additional triggers comprise an additional criteria portion and an additional payload portion, the additional criteria portion identifying one or more additional criteria and the additional payload portion identifying an additional application request, and wherein the system is further configured to send the one or more additional application requests responsive to the one or more additional triggers having the satisfied one or more additional criteria.

18. The system as recited in claim 14, the system further configured to send the application request to an application store located remote from the system.

19. The system as recited in claim 14, wherein the system comprises a trigger store on which the multiple triggers are stored and a monitor module capable of: monitoring the data corresponding to the media content being played back; detecting when the data satisfies the one or more criteria of the one or more of the multiple triggers; and sending the application request identified in the payload portion of the one or more of the multiple triggers having the satisfied one or more criteria.

20. The system as recited in claim 14, wherein the system is configured to play the application to provide enhanced functionality to the media content being played back.
